(19) United States
(12) Patent Application Publication
(10) Pub. No.: US 2013/0003493 A1
(43) Pub. Date: Jan. 3, 2013

(54) RETRACTABLE MIXER SYSTEM AND METHOD OF USING SAME

(76) Inventor: Alton PAYNE, Windsor Junction (CA)

(21) Appl. No.: 13/536,211

(22) Filed: Jun. 28, 2012

(30) Foreign Application Priority Data
Jun. 28, 2011 (CA) 2744652

(51) Int. Cl. B01F 7/06

(52) U.S. Cl. 366/286

(57) ABSTRACT

A retractable mixer system and a method of using the retractable mixer system to clean sludge build-up in a tank is disclosed. The retractable mixer system includes a drive shaft, a retractable propeller assembly and a motor for rotating the drive shaft and the retractable propeller assembly attached to the drive shaft. By using the retractable mixer system at an existing access point or a newly created access point, the sludge build-up may be cleaned even when the sludge level is above the access point.

### TECHNICAL FIELD

The present disclosure relates to a tank mixer, more particularly a retractable mixer system for a tank.

### BACKGROUND

Petroleum refineries and/or bulk storage terminals typically have a series of large above-ground storage tanks (ASTs) designed to store crude oil and other hydrocarbon-based materials. The ASTs are generally constructed of steel but some ASTs may be constructed of concrete. Because ASTs store hydrocarbon-based materials, it is a regular occurrence to have sludge build-up at the bottom of the tanks. One of the main components of sludge is paraffin wax, which is a naturally occurring long chain hydrocarbon found in crude oil and other hydrocarbon-based contents. An example of paraffin is petroleum jelly or Vaseline™. Over time, the paraffin component crystallizes, gravitates to the bottom of the tank and forms a sludge layer. Another long chain hydrocarbon that can gather is asphaltene, a long chain hydrocarbon used to make asphalt. However, in addition to the paraffin wax water can accumulate in the sludge layer as water coagulates and forms pockets (commonly referred to as “slug”) within the sludge. This is due to the fact that water and oil do not mix. The sludge layer may also contain non-hydrocarbon particles such as sand or rust scale.

Because the sludge layer is high in viscosity and contains water and other non-hydrocarbon particles, it is undesirable for sludge to reach the refinery. These foreign particles within the sludge can cause enormous pressure spikes and undermine the refining process. Thus, sludge must be removed from the tank before it accumulates above a certain level by pumping or vacuuming the sludge out of the tank. If the sludge layer is too heavy for pumping or vacuuming, it may be mixed with lighter oil prior to pumping or vacuuming. However, if the sludge level is above the manway, the inside of the AST cannot be accessed and presents a cleaning challenge. Typically, in this situation, access is created above the sludge level. While some ASTs are equipped with manway-mounted mixers, this problem still persists if the manway-mounted mixer breaks down and requires servicing prior to mixing the sludge.

Accordingly, a mixing system that is operable even when the sludge layer is above the manway remains highly desirable.

### SUMMARY

According to an aspect of the technology, a retractable mixer system for cleaning sludge build-up in a tank storing hydrocarbon-based product through an access point on the tank is disclosed. The retractable mixer system includes a drive shaft; a retractable propeller assembly coupled to one end of the drive shaft, the retractable propeller assembly comprising at least one propeller blade movable between a folded position and an unfolded position such that when the at least one propeller blade is in the folded position, the retractable propeller assembly fits through the access point; and a motor coupled to the other end of the drive shaft for rotating the drive shaft.

According to another aspect of the technology, a method of cleaning sludge build-up in a tank storing hydrocarbon-based product through an access point on the tank, the access point being openeable and closeable by a close-valve, is disclosed. The method includes providing a retractable tank mixer including a drive shaft having a first end and a second end; a retractable propeller assembly coupled to the first end of the drive shaft, the retractable propeller assembly comprising at least one propeller blade movable between a folded position and an unfolded position such that when the at least one propeller blade is in the folded position, the retractable propeller assembly fits through the access point; and a motor coupled to the second end of the drive shaft for rotating the drive shaft. The method further includes inserting the retractable tank mixer into the access point with the retractable propeller assembly being inserted in the folded position, the retractable tank mixer being inserted until the propeller assembly encounters the close-valve; opening the close-valve to allow the retractable tank mixer to be further inserted into the tank; and activating the motor to rotate the retractable propeller assembly.

In some embodiments, the retractable mixer system includes a column assembly for mounting the retractable mixer system at the access point, the column assembly being configured to align the drive shaft with the access point when the retractable mixer system is mounted to the column assembly.

In some embodiments, the retractable mixer system includes a bearing assembly configured to form a tight seal with the column assembly when coupled to the column assembly.

In some embodiments, the column assembly is coupled to a pipe assembly on the access point.

In some embodiments, the column assembly is coupled to a side surface of the tank.

In some embodiments, the column assembly is coupled to the side surface of the tank by a flange assembly.

In some embodiments, the column assembly comprises a drain port.

In some embodiments, the at least one propeller blade is angled forward.

In some embodiments, the at least one propeller blade comprises a hinged portion and a non-hinged portion coupled by a hinge, the hinge being parallel to a centre axis of the at least one propeller blade.

In some embodiments, the hinged portion is foldable forward against the non-hinged portion.

In some embodiments, the access point is provided by a pipe assembly, a cold tap or a hot tap on the tank.

In some embodiments, the tank is an above-ground storage tank (AST).

In some embodiments, the at least one propeller blade being foldable forward to the folded position.

In some embodiments, the method includes attaching a column assembly at the access point of the tank, and mounting the retractable tank mixer onto the column assembly, the column assembly aligning the drive shaft of the retractable tank mixer with the access point.

In some embodiments, the method includes coupling a bearing assembly to the column assembly, the bearing assembly configured to create a tight seal with the column assembly to prevent leak from the access point when the close-valve is opened, and positioning the retractable tank mixer through the bearing assembly such that the drive shaft rotates about the bearing assembly.

In some embodiments, the method includes draining the hydrocarbon-based product collected in the column assembly.

In some embodiments, the access point has a pipe assembly with the close-valve and the column assembly is attached to the pipe assembly.

In some embodiments, the column assembly is attached at the access point by a flange assembly, the flange assembly being mounted to a side surface of the tank, and the column assembly having the close-valve.

In some embodiments, the access point is created using a cold tap or a hot tap.

### BRIEF DESCRIPTION OF THE DRAWINGS

Further features and advantages of the present technology will become apparent from the following detailed description, taken in combination with the appended drawings, in which:

FIG. 1A illustrates an above-ground storage tank with sludge build-up below the manway;

FIG. 1B illustrates an above ground storage tank with sludge build-up above the manway;

FIG. 2 illustrates a retractable mixer system according to an embodiment of the present technology;

FIG. 3 illustrates an above-ground storage tank having sludge build-up above the manway that requires cleaning;

FIG. 4 illustrates the above-ground storage tank of FIG. 3 having a pipe assembly;

FIG. 5 illustrates a column assembly mounted to the pipe assembly of FIG. 4;

FIG. 6 illustrates the retractable mixer system being inserted into the column assembly;

FIG. 7 illustrates the retractable mixer system encountering the close-valve on the pipe assembly;

FIG. 8 illustrates the retractable mixer system being inserted into the above-ground storage tank through the access point after opening the close-valve on the pipe assembly and being activated;

FIG. 9 illustrates the mixing of the sludge and the fluid as the retractable mixer system is activated;

FIG. 10 illustrates the use of multiple retractable mixer system;

FIG. 11 illustrates a front view of the retractable propeller assembly in the unfolded position;

FIG. 12A illustrates a view of the propeller blade along 12-12 of FIG. 11;

FIG. 12B illustrates a view of the propeller blade having a hinge along 12-12 of FIG. 11;

FIG. 13 illustrates a flange assembly being mounted on a side surface of the above-ground storage tank;

FIG. 14 illustrates a column assembly being mounted on the flange assembly;

FIG. 15 illustrates a drill assembly being inserted into the column assembly of FIG. 14 and encountering the close-valve on the column assembly;

FIG. 16 illustrates a drill assembly reaching the side surface of the above-ground storage tank after opening the close-valve on the column assembly and the drill assembly being activated to create the access point; and

FIG. 17 illustrates the retractable mixer system being inserted into the newly created access point.

It will be noted that throughout the appended drawings, like features are identified by like reference numerals.

### DETAILED DESCRIPTION

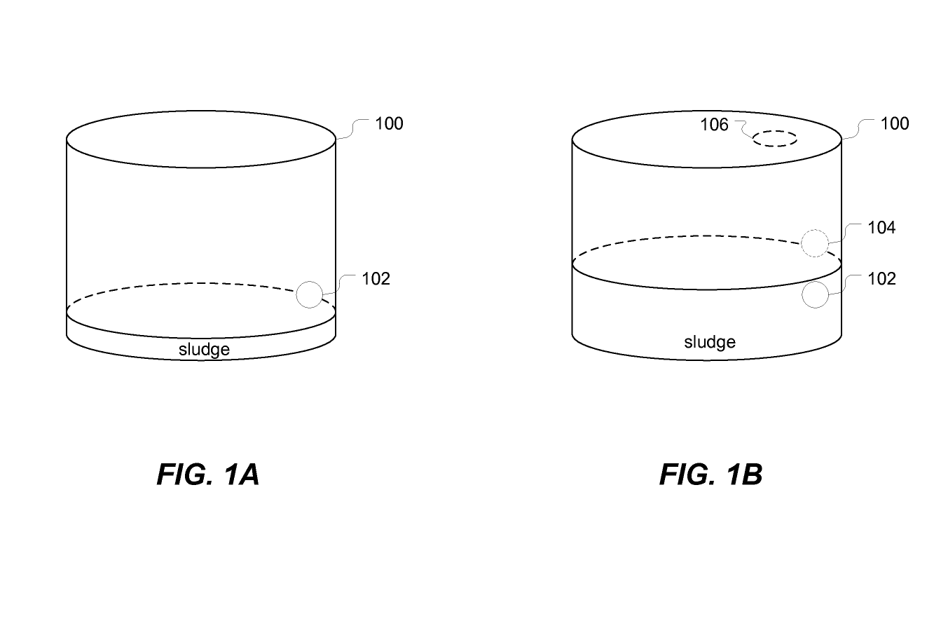

Embodiments are described below, by way of example only, with reference to FIGS. 1-17.

The present disclosure describes a retractable mixer system and method for using the mixer system in a hydrocarbon storage tank. Because of the retractable nature of the mixer system, the manway is not required to be removed prior to installing the mixer system. The retractable mixer system may be installed on ASTs' existing pipe assembly, cold tap or hot tap. The present disclosure further describes a method of using the retractable mixer system where the AST does not have an existing pipe assembly, cold tap or hot tap. Thus, using the present technology, sludge build-up in the ASTs can be mixed and removed even if the sludge layer is above the manway, preventing the opening of the manway.

As shown in FIG. 1A, AST 100 may store crude or other hydrocarbon-based product. At first, there may be no sludge buildup or a negligible amount of sludge at the bottom of the AST 100. However, as paraffin in the hydrocarbon-based product begins to crystallize and starts to settle at the bottom of the AST 100 as sludge layer, a need arises to remove the sludge prior to using the hydrocarbon-based product (such as in a refinery). When the manway 102 is above the sludge layer as in FIG. 1A, the manway 102 may be removed to access the sludge in the AST 100. Removing the sludge may be achieved by pumping or vacuuming the sludge out of the AST 100. If the sludge is too heavy, the sludge may be mixed with lighter oil to decrease the viscosity of the sludge prior to pumping or vacuuming. Mixing may be achieved using a nozzle or a mixer. However, if the sludge level rises above the manway 102 as in FIG. 1B, the manway 102 cannot be removed. If the AST 100 has a mixer internally mounted on the inside surface of the manway 102, it may be used to mix the sludge prior to removal. However, if the internally mounted mixer is broken or the AST 100 does not have such a mixer, a new manway 104 would need to be created above the sludge level. Alternatively, a hole 106 may be created on the roof of the AST 100; however, if the AST has a floating roof, the roof must be opened or sometimes completely removed, which is a labour intensive and safety sensitive process. A floating roof is a roof that floats on top of the product in the AST and rises/sinks with the level of the product. For each of these solutions (i.e. new manway 104, new hole 106 in the roof, or removing the floating roof), the AST 100 would have to be taken out of commission for an extended period of time. Moreover, the cleaning process would be very expensive, labour intensive and safety sensitive.

Using the retractable mixer system in the present disclosure, an access point on the AST 100 may be used to install the mixer system without removing the manway or creating a new manway above the sludge level. An access point may be an existing pipe assembly, cold tap or hot tap that allows access to the inside of the AST 100. If the AST 100 does not have an existing access point, a new cold tap or hot tap may be created prior to installing the retractable mixer system at the new access point. Using this system, the AST 100 need not be taken out of commission and the sludge removal process is cheaper, safer, and faster than conventional systems and methods.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

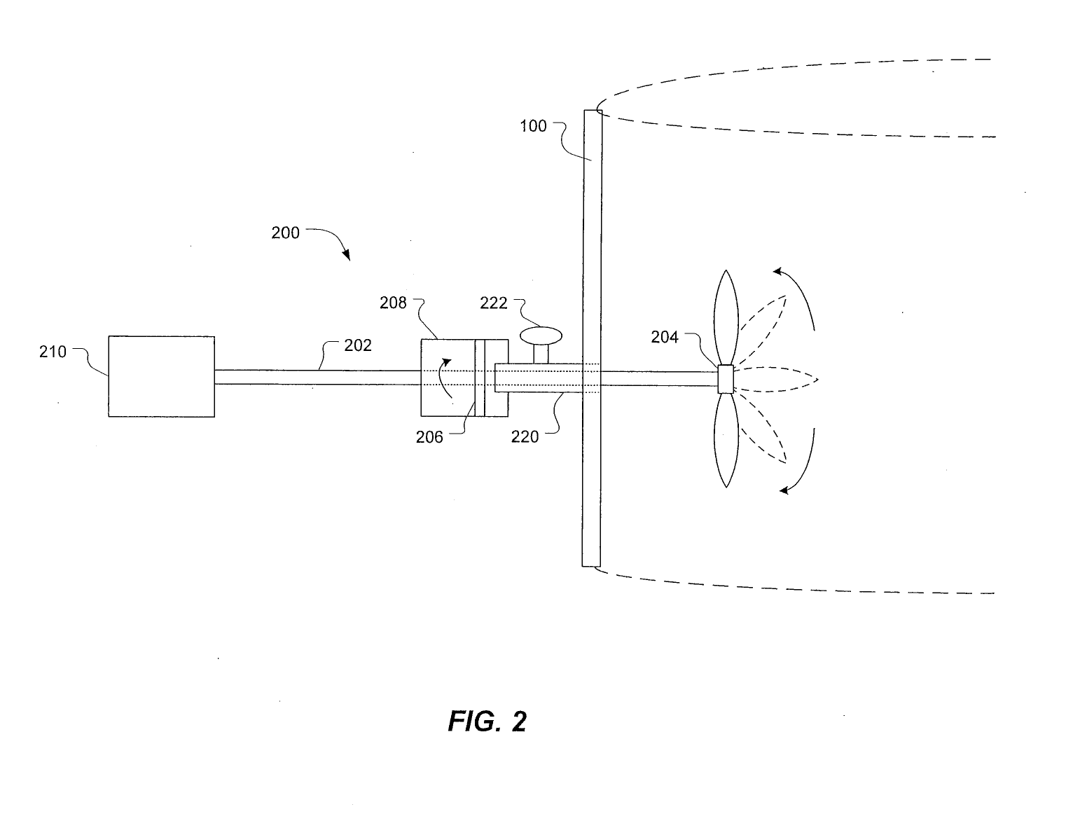

Referring to FIG. 2, an embodiment of the retractable mixer system is shown. In this embodiment, the retractable mixer system 200 includes a drive shaft 202, a retractable propeller assembly 204, a bearing assembly 206 and a column assembly 208. While the elements in FIG. 2 are shown as separate components, it will be understood that these elements may be performed by a single element or any other combination. For example, the column assembly 208 may integrate the bearing assembly 206. It will also be understood that the retractable mixer system may be made of non-sparking material to reduce any fire hazard since the retractable mixer system may be used with tanks storing hydrocarbon-based materials.

In the particular embodiment shown in FIG. 2, the AST 100 has an access point in the form of a pipe assembly 220 having a close-valve 222. It will be understood that the access point may be an existing pipe assembly, cold tap or hot tap. This access point may be at the manway (such as manway 102 in FIG. 1) or a side surface of the AST 100. Moreover, it will be understood that where the AST 100 does not have an existing pipe assembly 220, a new opening accessing the internals of the AST 100 may be created using known methods such as a cold tap or hot tap.

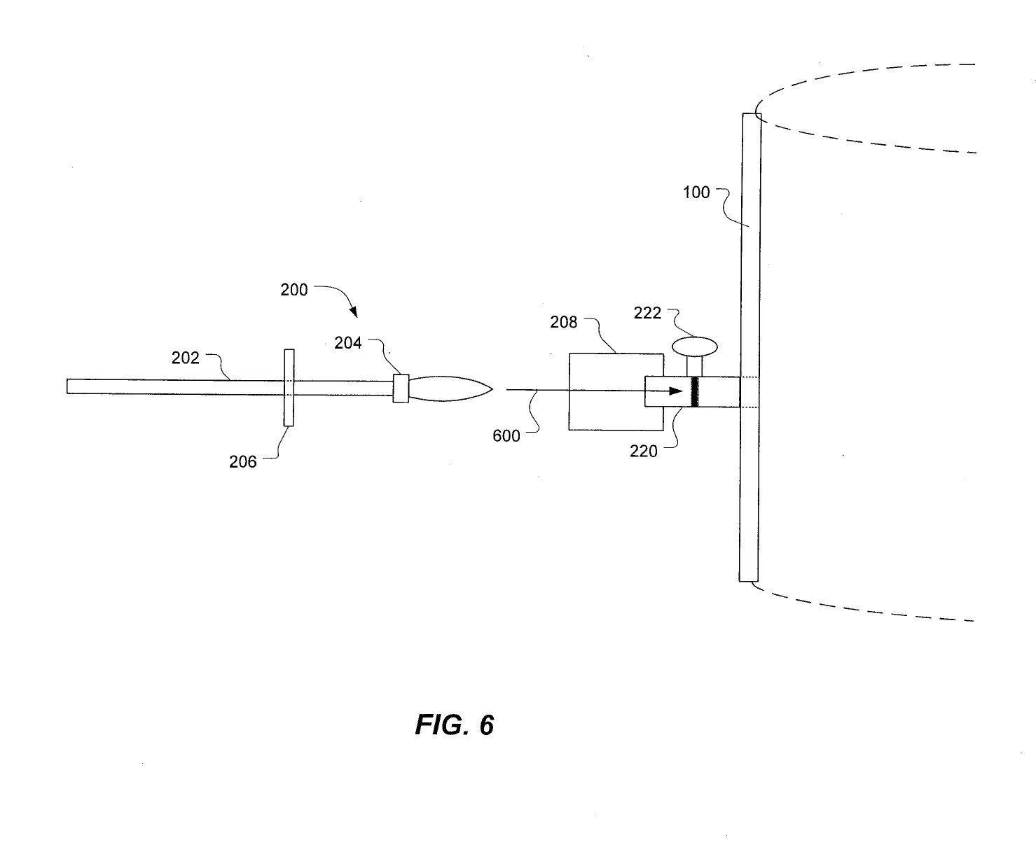

At one end of the drive shaft 202, there is mounted the retractable propeller assembly 204. The retractable propeller assembly 204 has at least one propeller blade that is movable between a folded position and an unfolded position. In one implementation, each propeller blade is pivotally mounted to the retractable propeller assembly 204. As shown in FIG. 2, each propeller blade is designed to fold along the axis of rotation of the drive shaft 202. In one embodiment, the propeller blade folds forward, away from the drive shaft, as shown by the dotted lines in FIG. 2. The term “forward” in this context generally refers to the direction of insertion of the retractable mixer system 200 (i.e. arrow 600 in FIG. 6). The foldable nature of the retractable propeller assembly 204 allows propeller blades to fit through the pipe assembly 220 and become unfolded when the mixer system is activated. Consequently, there is no need to open the manway (such as manway 102) to access the interior space of the AST 100 to install a cleaning mechanism such as a tank mixer or a nozzle system. Rather, the retractable mixer system 200 is inserted into an access point such as an existing or new pipe assembly 220. When the motor 210 is activated and the drive shaft 202 begins to rotate, the propeller assembly opens from its folded position as shown in FIG. 2 because of the centrifugal force of the spinning drive shaft 202. While the propeller blades in FIG. 2 are shown to fold forward and away from the drive shaft 202, it will be understood that propeller blades may be designed to fold against the drive shaft 202.

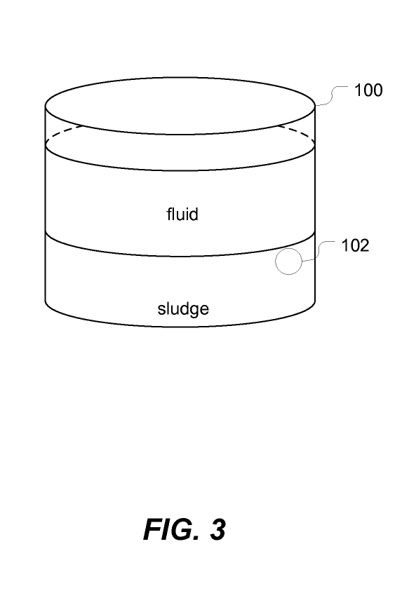

Now referring to FIGS. 3-10, an exemplary use of the retractable mixer system 200 will be described. In FIG. 3, an AST 100 is shown having manway 102 located near the bottom of the AST 100. While the AST 100 may vary in sizes, they are typically between 40 to 300 feet in diameter and 48 to 56 feel in height. The manway 102, which is typically between 30 to 36 inches in diameter, may be located between 36 to 42 feet above ground. An AST 100 may have one or several manways, depending on the size of the AST 100.

The AST 100 is used to store hydrocarbon-based contents, such as crude, heavy or light oil, and any other hydrocarbon-based product. As described above, sludge develops at the bottom of the AST 100 over time and a tank cleaning challenge is presented when the sludge level is above the manway 102.

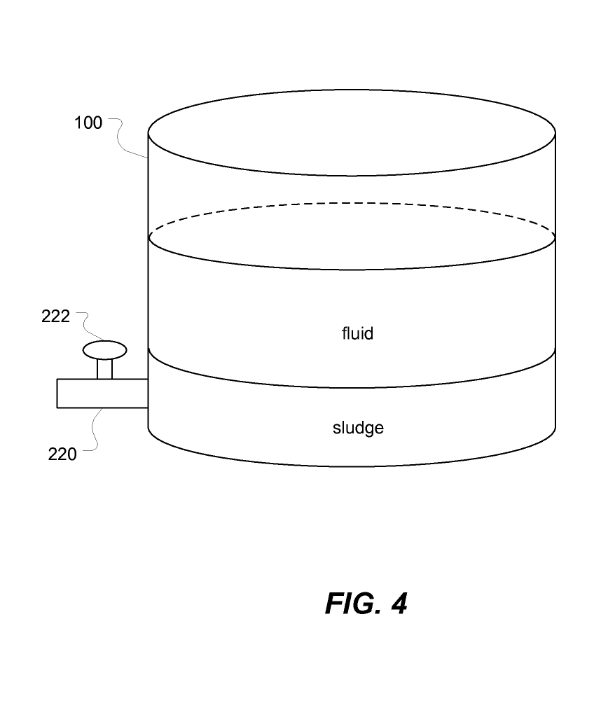

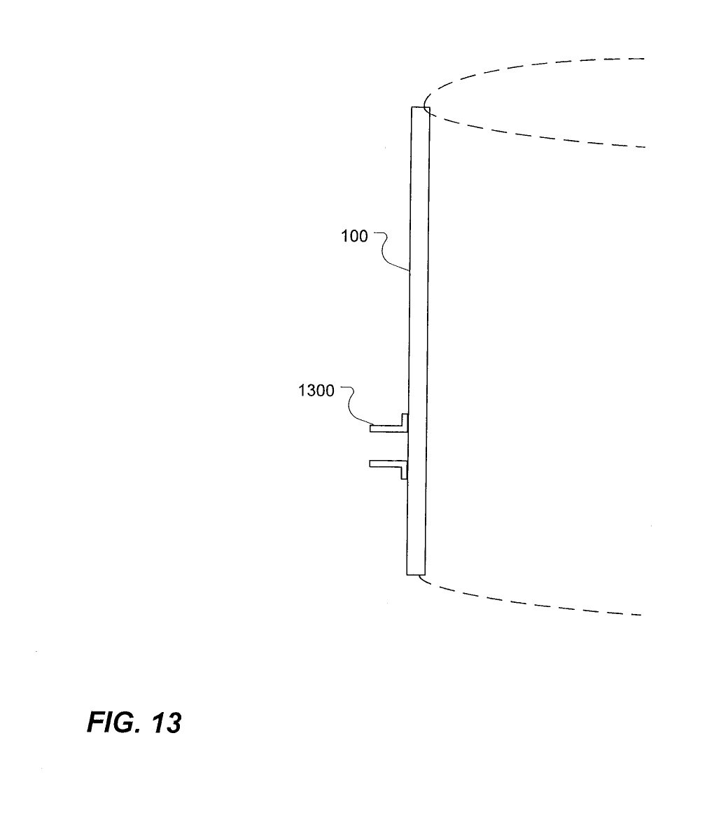

As shown in FIG. 4, the AST 100 may have an access point in the form of an existing pipe assembly 220 with a close-valve 222. It will be understood that the pipe assembly 220 may be more elaborate or simpler than as shown in FIG. 4. The pipe assembly 220 may be on a manway (such as manway 102) or a side surface of the AST 100. It will also be understood that the access point may be in other forms such as a cold tap or a hot tap, which may be created if the AST 100 does not have an access point available. The exemplary use of the retractable mixer system 200 will be described with the assumption that the access point is in the form of the pipe assembly 220 with a close-valve 222. A further exemplary use of the retractable mixer system 200 where the AST 100 does not have an existing access point will be described below using FIGS. 13-17.

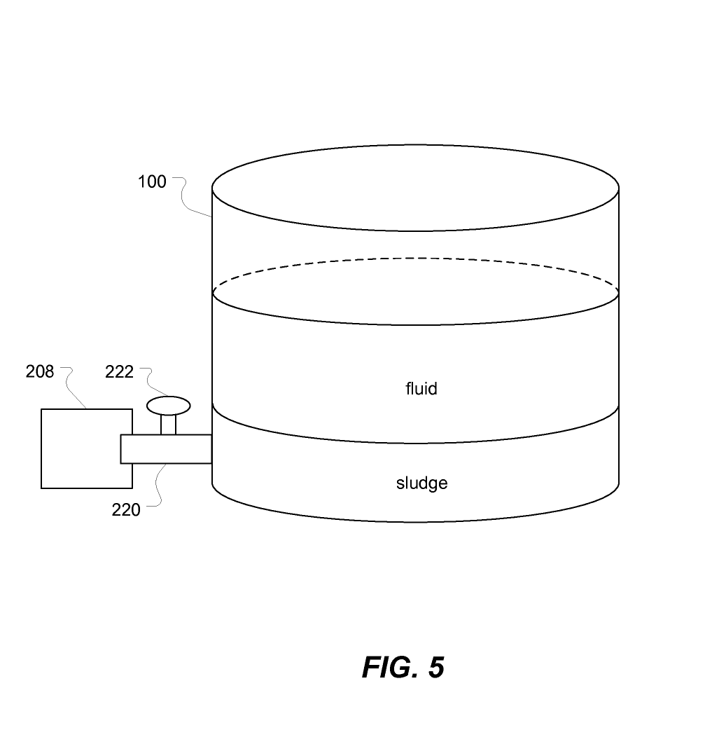

With the pipe assembly 220 in place, the column assembly 208 is mounted on the pipe assembly 220 as shown in FIG. 5. The column assembly 208 is used to secure the retractable mixer system 200 at the access point, which, in this implementation, is the pipe assembly 220. The column assembly 208 is designed such that when the retractable mixer system 200 is installed with the column assembly 208, the drive shaft 202 of the retractable mixer system 200 is aligned with the access point. In this embodiment, the drive shaft 202 would line up with the pipe assembly 220.

The column assembly 208 may be mounted using various methods. For example, the column assembly 208 may include a flange (not shown) to releasably mount the column assembly 208 to the pipe assembly 220. In another example, the column assembly 208 may be welded to the external side of the AST 100 by a flange assembly (e.g. 1300 in FIG. 13)

After mounting the column assembly 208, the retractable tank mixer is prepared. In this particular embodiment, the drive shaft 202 is fitted through the bearing assembly 206. Thereafter, the retractable propeller assembly 204 is mounted on one end of the drive shaft 202. The assembled tank mixer comprising of the drive shaft 202, bearing assembly 206 and retractable propeller assembly 204 is then inserted through the column assembly 208, generally in the direction 600 as shown in FIG. 6. In another embodiment, the bearing assembly 206 may be inserted into the column assembly 208. Thereafter, the retractable propeller assembly 204 may be mounted on one end of the drive shaft 202 and inserted, with the end having the retractable propeller assembly 204 first, into the bearing assembly 206 and the pipe assembly 220.

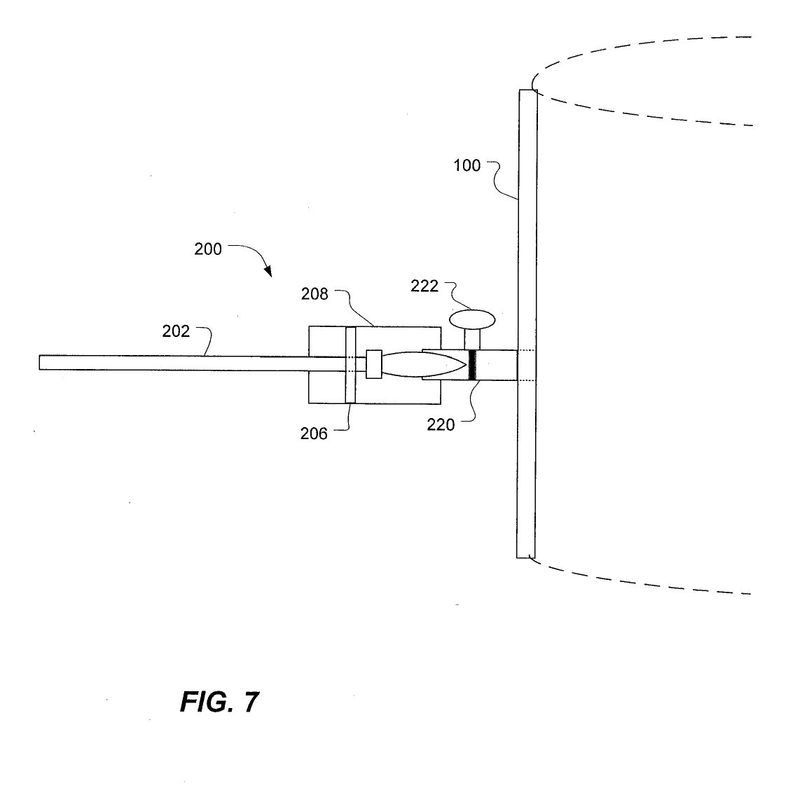

The bearing assembly 206 may be designed such that it forms a tight seal against the inner surface of the column assembly 208. Thus, when the assembled tank mixer is inserted through the column assembly 208, a tight seal is created in the column assembly 208, as shown in FIG. 7. As the tank mixer is pushed further into the pipe assembly 220, the tip of the propeller assembly encounters the close-valve 222, which prevents the tank mixer from proceeding any further. The close-valve 222 prevents any content in the AST 100 from flowing out of the AST 100. At this point, the close-valve 222 is loosened and the tank mixer is pushed further into the pipe assembly 220. However, because the bearing assembly 206 and the column assembly 208 form a tight seal, fluid is prevented from leaking out of the column assembly 208.

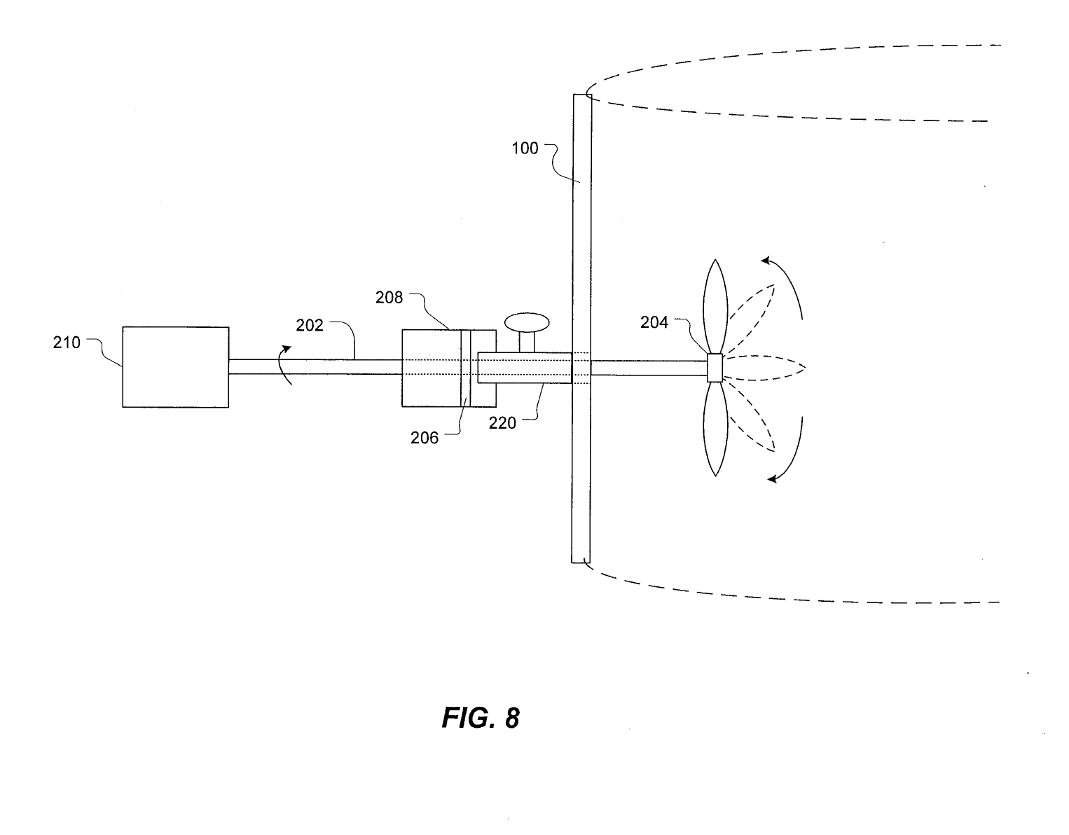

Once the tank mixer is fully inserted into the AST 100, which is typically when the retractable propeller assembly typically extends between 12 to 36 inches, but can vary, past the interior surface of shell wall, the motor 210 is attached to the other end of the drive shaft 202. When the motor 210 is activated, the drive shaft 202 rotates about the bearing assembly 206, which is aligned with the pipe assembly 220. As the drive shaft 202 rotates, the centrifugal force forces the propeller blades on the retractable propeller assembly 204 to unfold as shown in FIG. 8.

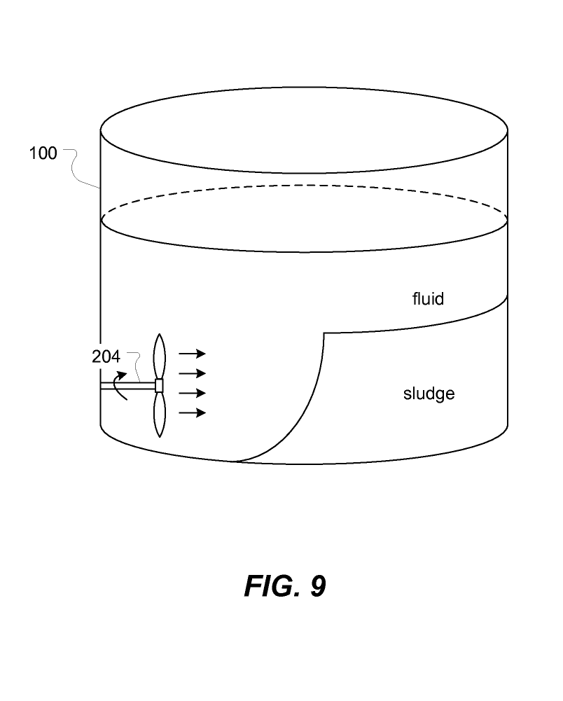

As a result, the spinning propeller blade starts to mix the sludge as shown in FIG. 9. Additionally, to efficiently mix the sludge, each propeller blade on the retractable propeller assembly 204 may be angled to further aid in pushing the sludge away from the mixer, toward the centre of the AST 100, including radially toward the centre to thoroughly mix the sludge. This will be further explained below, along with the additional folding feature of the propeller blades on the retractable propeller assembly 204.

As explained above, the AST 100 may include multiple access points comprising of manways, pipe assemblies, cold taps and hot taps. To effectively and evenly mix the sludge in the AST 100, a retractable mixer system may be installed at the multiple access points of the AST 100. If the AST 100 does not have any existing pipe assembly, a cold tap or hot tap may be used as an entry point for the retractable mixer system.

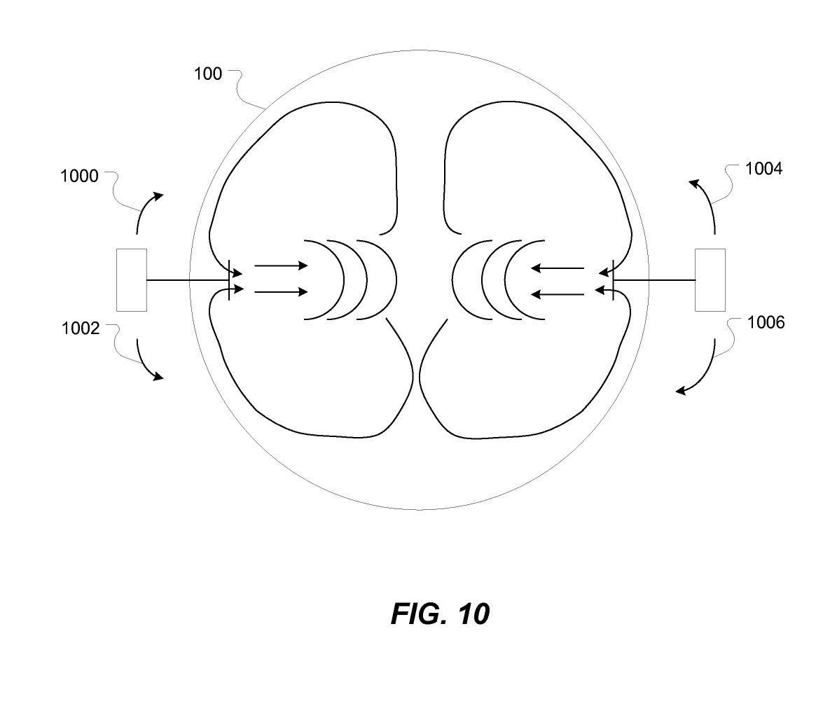

As shown in FIG. 10, there is shown a top view of the AST 100 with two retractable mixer systems installed at opposite ends. By having two retractable mixer systems as shown, the sludge in the AST 100 can be evenly and thoroughly mixed by the propeller blades. Moreover, because the drive shaft 202 rotates about the bearing assembly 206, the mixer system is able to pivot side to side as shown by arrows 1000-1006. This increases the mixing range of the retractable mixer system and contributes to the even-mixing of the sludge in the AST 100. It will be understood that more than two retractable mixer systems according to the present disclosure may be installed on the AST 100 to further speed up the mixing process and increase the mixing range of the mixer system.

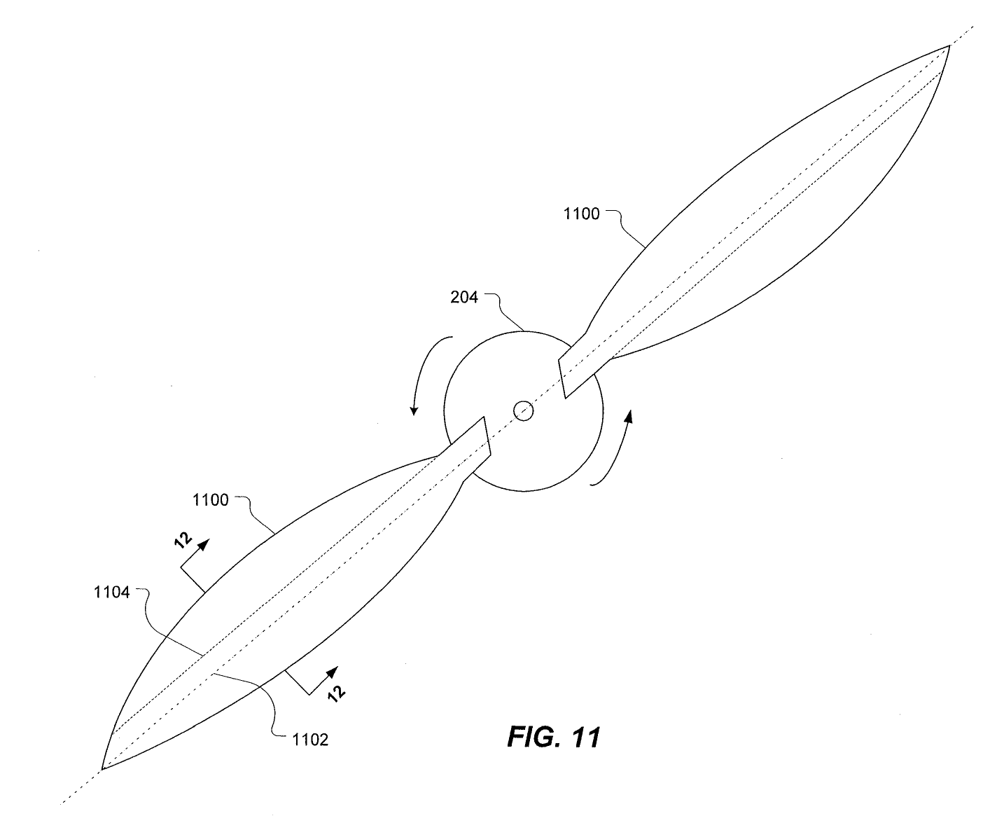

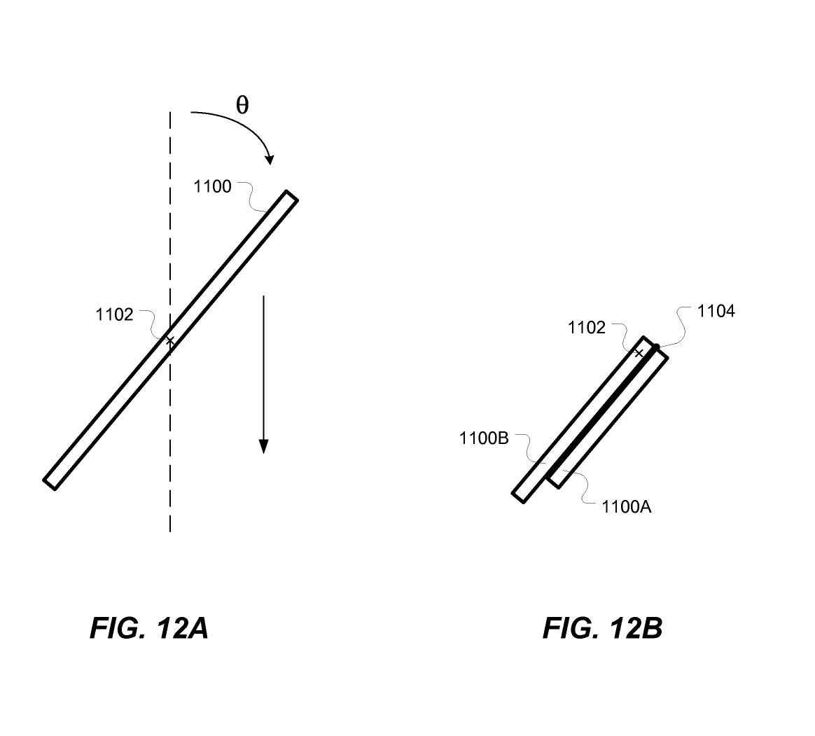

Now turning to FIG. 11, a front view of the propeller assembly 204 is shown, with the propeller blades 1100 in the unfolded position. As explained above, the propeller blades 1100 may be angled to displace the sludge toward the centre of the AST 100. In one embodiment, the propeller blade 1100 may be angled forward at θ degrees from the centre axis 1102. The term “forward” in this context refers to the propeller blade 1100 being tilted in the direction of the propeller blade movement (see FIG. 12A). Angle θ may be any angle between 0-90 degrees.

Moreover, the propeller blade may have a hinge 1104 on the propeller blade 1100 as shown in FIGS. 11 and 12B. With the hinge 1104, the hinged portion 1100A of the propeller blade 1100 may be folded to reduce the profile of the propeller blade 1100. In one embodiment, the hinged portion 1100A folds forward and against the non-hinged portion 1100B. This allows larger sized propeller blades 1100 than a propeller blade 1100 having no hinge to be attached to the retractable propeller assembly 204. In FIG. 12B, the hinge 1104 is located approximately 1 cm from the centre axis 1102. This means that, when compared to a propeller blade 1100 without a hinge, a propeller blade nearly double the size of a non-hinged propeller blade may be attached to the retractable propeller assembly 204. While the foregoing has been described with the hinge 1104 being located 1 cm from the centre axis 1102, it will be understood that the hinge 1104 may be located at less than or more than 1 cm away from the centre axis 1102, depending on the dimensions of each propeller blade.

Thus, the retractable mixer system allows sludge in the AST 100 to be cleaned even when the sludge is above the manway or an existing access point. As discussed, the retractable mixer system may be used to mix the sludge in the AST 100 without removing the manway, or creating a new manway or access hole above the sludge level. This allows the sludge in the AST 100 to be dealt with quickly without expending too much time or resources and without taking the AST 100 out of commission during the cleaning process.

Another embodiment of the present technology will now be shown. In this embodiment, the AST 100 does not have an existing pipe assembly (e.g. 220 in FIG. 2). Thus, an access point is created on the AST 100 using an entry method such as cold tapping or hot tapping.

Referring to FIG. 13, a flange assembly 1300 is installed on a side of the AST 100. In another embodiment, the flange assembly 1300 may be installed on an existing manway (e.g. manway 102 of FIG. 1) of the AST 100. The installation of the flange assembly 1300 may be accomplished by welding the flange assembly 1300 to the side of the AST 100 or the manway. In other implementations, the flange assembly 1300 may be installed on the manway using existing nuts and bolts on the manway.

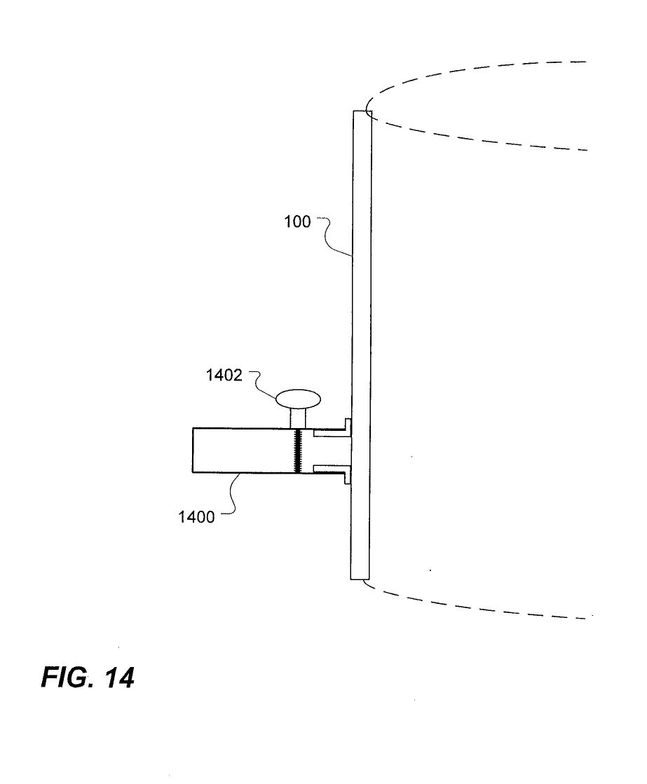

After installing the flange assembly 1300, a column assembly 1400 is coupled to the flange assembly 1300 as shown in FIG. 14. Again, the column assembly 1400 may be coupled to the flange assembly 1300 using various methods including welding. In this implementation, the column assembly 1400 incorporates a close-valve 1402 that will serve to open and close the access point after the AST 100 has been tapped. The column assembly 1400 is similar to the column assembly 220; however, it is mounted on the flange assembly 1300 and the close-valve 1402 is on the column assembly 1400, rather than on the pipe assembly 220. While the column assembly 1400 and the flange assembly 1300 have been described as being separate elements, it will be understood that they may be a single or plurality of elements. For example, the column assembly 1400 may incorporate the flange assembly 1300.

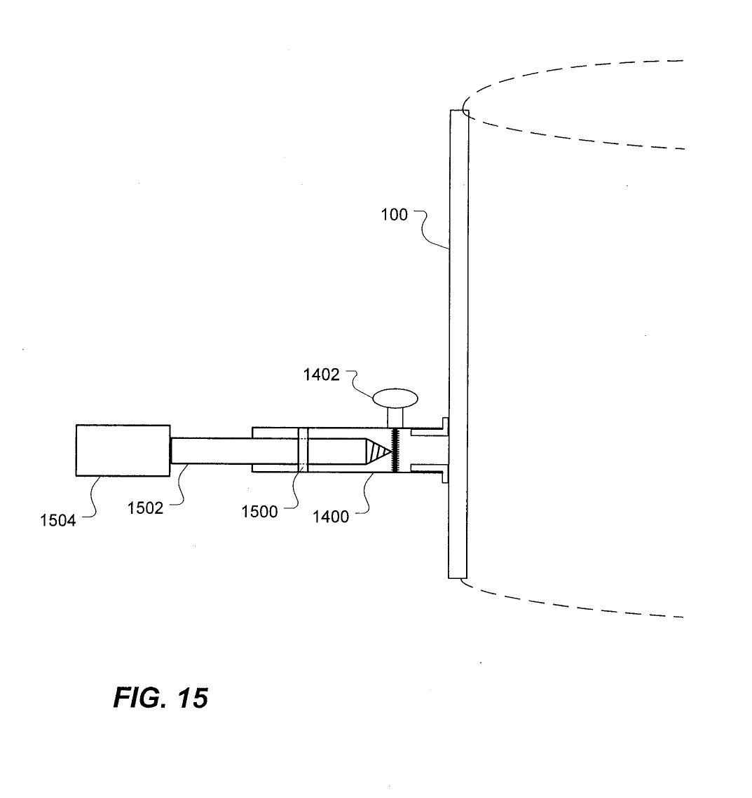

With the close-valve 1402 in the closed position, a bearing assembly 1500 is inserted into the column assembly 1400 as shown in FIG. 15. Like the bearing assembly 206, the bearing assembly 1500 forms a tight seal against the inside surface of the column assembly 1400. It also allows the drill assembly 1502 to rotate about the bearing assembly 1500 when drilling through the AST 100 to create the access point. In another embodiment, the drill assembly 1502 may be placed through the bearing assembly 1500 and inserted together into the column assembly 1400.

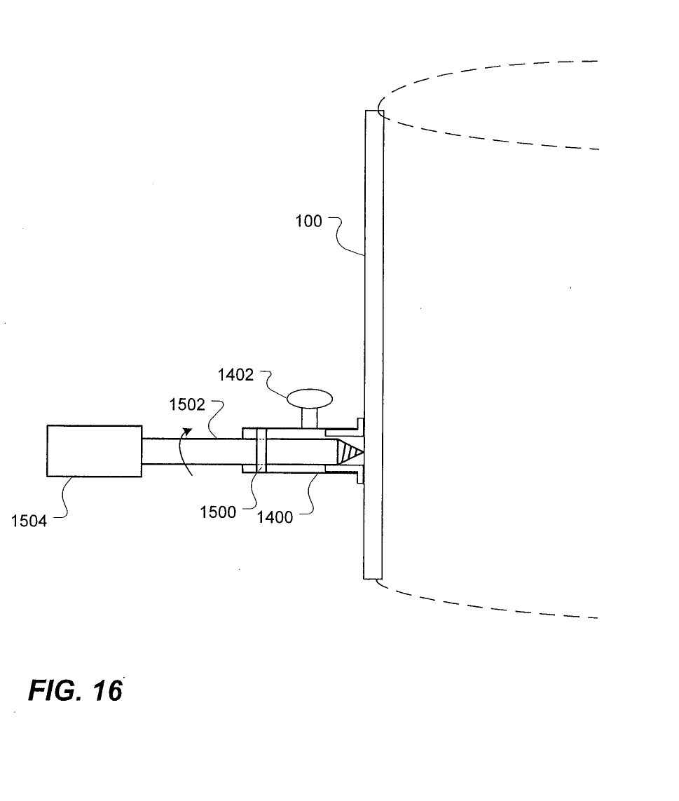

The drill assembly 1502 is inserted into the column assembly 1400 and through the bearing assembly 1500 until the tip of the drill assembly 1502 is blocked by the close-valve 1402. At this point, the close-valve 1402 is opened to further insert the drill assembly 1502 until the tip of the drill assembly 1502 reaches the AST 100 (see FIG. 16). The motor 1504 is then activated to rotate the drill assembly 1502. As the drill assembly 1502 penetrates through the side wall of the AST 100, there will be no leak outside of the column assembly 1400 since the bearing assembly creates a tight, leak proof seal against the inside surface of the column assembly 1400.

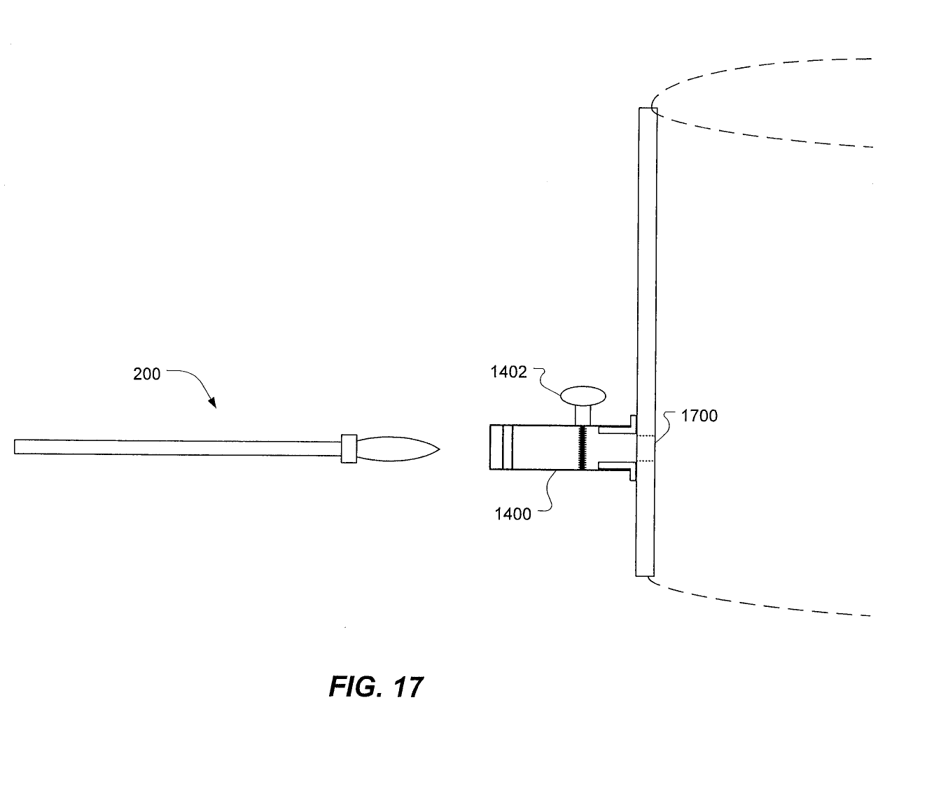

After creating the access point (i.e. 1700 in FIG. 17) with the drill assembly 1502, the drill assembly 1502 is pulled away from the access point 1700 and the close-valve 1402 is closed. With the close-valve 1402 closed, the drill assembly 1502 can be safely removed from the column assembly 1400. A small amount of hydrocarbon material may be captured in the column assembly 1400 during the opening and closing of the close-valve 1402. In one embodiment, the column assembly 1400 may include a drain port (not shown) to drain the hydrocarbon material collected in the column assembly 1400.

With the cold tap in place, and the close-valve 1402 in the closed position, the retractable mixer system 200 can be inserted through the newly created access point as previously described.

While the present technology has been described in terms of specific implementations and configurations, further modifications, variations, and refinements may be made without departing from the inventive concepts presented herein. The scope of the exclusive right sought by the Applicant is therefore intended to be limited solely by the appended claims.

What is claimed is:

1. A retractable mixer system for cleaning sludge build-up in a tank storing hydrocarbon-based product through an access point on the tank, the retractable mixer system comprising:
a drive shaft;
a retractable propeller assembly coupled to one end of the drive shaft, the retractable propeller assembly comprising at least one propeller blade movable between a folded position and an unfolded position such that when the at least one propeller blade is in the folded position, the retractable propeller assembly fits through the access point; and
a motor coupled to the other end of the drive shaft for rotating the drive shaft.

2. The retractable mixer system according to claim 1, further comprising:
a column assembly for mounting the retractable mixer system at the access point, the column assembly being configured to align the drive shaft with the access point when the retractable mixer system is mounted to the column assembly.

3. The retractable mixer system according to claim 2, further comprising:
a bearing assembly configured to form a tight seal with the column assembly when coupled to the column assembly.

4. The retractable mixer system according to claim 2, wherein the column assembly is coupled to a pipe assembly on the access point.

5. The retractable mixer system according to claim 2, wherein the column assembly is coupled to a side surface of the tank.

6. The retractable mixer system according to claim 5, wherein the column assembly is coupled to the side surface of the tank by a flange assembly.

7. The retractable mixer system according to claim 2, wherein the column assembly comprises a drain port.

8. The retractable mixer system according to claim 1, wherein the at least one propeller blade is angled forward.

9. The retractable mixer system according to claim 1, wherein the at least one propeller blade comprises a hinged portion and a non-hinged portion coupled by a hinge, the hinge being parallel to a centre axis of the at least one propeller blade.

10. The retractable mixer system according to claim 9, wherein the hinged portion is foldable forward against the non-hinged portion.

11. The retractable mixer system according to claim 1, wherein the access point is provided by a pipe assembly, a cold tap or a hot tap on the tank.

12. The retractable mixer system according to claim 1, wherein the tank is an above-ground storage tank (AST).

13. The retractable mixer system according to claim 1, wherein the at least one propeller blade being foldable forward to the folded position.

14. A method of cleaning sludge build-up in a tank storing hydrocarbon-based product through an access point on the tank, the access point being openeable and closeable by a close-valve, the method comprising:
providing a retractable tank mixer comprising:
a drive shaft having a first end and a second end;
a retractable propeller assembly coupled to the first end of the drive shaft, the retractable propeller assembly comprising at least one propeller blade movable between a folded position and an unfolded position such that when the at least one propeller blade is in the folded position, the retractable propeller assembly fits through the access point; and
a motor coupled to the second end of the drive shaft for rotating the drive shaft;
inserting the retractable tank mixer into the access point with the retractable propeller assembly being inserted in the folded position, the retractable tank mixer being inserted until the propeller assembly encounters the close-valve;
opening the close-valve to allow the retractable tank mixer to be further inserted into the tank; and
activating the motor to rotate the retractable propeller assembly.

15. The method according to claim 14, further comprising:
attaching a column assembly at the access point of the tank; and
mounting the retractable tank mixer onto the column assembly, the column assembly aligning the drive shaft of the retractable tank mixer with the access point.

16. The method according to claim 15, further comprising:
coupling a bearing assembly to the column assembly, the bearing assembly configured to create a tight seal with the column assembly to prevent leak from the access point when the close-valve is opened; and
positioning the retractable tank mixer through the bearing assembly such that the drive shaft rotates about the bearing assembly.

17. The method according to claim 15, further comprising:
draining the hydrocarbon-based product collected in the column assembly.

18. The method according to claim 15, wherein the access point has a pipe assembly with the close-valve and the column assembly is attached to the pipe assembly.

19. The method according to claim 15, wherein the column assembly is attached at the access point by a flange assembly, the flange assembly being mounted to a side surface of the tank, and the column assembly having the close-valve.

20. The method according to claim 14, wherein the access point is created using a cold tap or a hot tap.
